(19) United States
(12) Patent Application Publication
(10) Pub. No.: US 2021/0342760 A1
(43) Pub. Date: Nov. 4, 2021

(54) SYSTEMS AND METHODS FOR UTILIZING CONSTRAINED MODES OF TRANSPORTATION

(71) Applicant: Lyft, Inc., San Francisco, CA (US)

(72) Inventors: Arkesh Jagdish Patel, San Francisco, CA (US); Rex See Chun Lam, San Francisco, CA (US); Gavin Sebastian Hurley, San Francisco, CA (US); Dennis Yu Cheng, San Francisco, CA (US)

(21) Appl. No.: 16/862,395

(22) Filed: Apr. 29, 2020

(51) Int. Cl. G06Q 10/06; G06F 3/0481

(52) U.S. Cl. CPC G06Q 10/06311; G06F 3/04817

(57) ABSTRACT

The disclosed computer-implemented method may include efficiently surfacing the availability of constrained transportation options such that the utilization of those options is at least partially maximized and directed to users for whom the options would be a positive user experience. During busy times, requests for transportation with a high estimated arrival time and/or to a low-demand area may not be the most efficient matches for constrained transportation options such as autonomous vehicles. Instead, waiting for a transportation request with a lower estimated arrival time and/or to a higher-demand area may be a better choice in terms of maximizing the percentage of time an autonomous vehicle spends transporting passengers and reducing the time passengers spend waiting for an autonomous vehicle. In some embodiments, dynamically altering the mode-availability radius of an autonomous vehicle may increase the utilization of the autonomous vehicle. Various other methods, systems, and computer-readable media are also disclosed.

### BACKGROUND

On-demand transportation, which may allow a user to request transportation from a dynamic transportation network at any time, is becoming an increasingly popular method of getting around. A user can access a transportation-network application on their mobile device to request transportation from their current location to their destination, and in response, the transportation network may fulfill the request by selecting a transportation provider to fulfill the request. In some cases, a dynamic transportation network may fulfill requests with different types of transportation, such as small-capacity vehicles, high-capacity vehicles, luxury vehicles, and even autonomous vehicles. Some types of vehicles may be constrained in how and where the vehicles can operate due to limitations related to the vehicles themselves, due to operator preferences (e.g., a driver preferring to stay within a certain region), or due to one or more of a variety of other factors. Accordingly, the instant disclosure identifies and addresses a need for improving transportation utilization and user experiences with on-demand transportation.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an illustration of an example constrained mode of transportation available to be matched with a requestor device and a potential requestor device.

FIG. 2 is an illustration of an example constrained mode of transportation available to be matched with a potential requestor device within an estimated time of an arrival threshold.

FIG. 3 is an illustration of an example set of estimated time of arrival thresholds.

FIG. 4 is an illustration of an example set of requestor devices with different destinations.

FIG. 5 is an illustration of an example set of requestor devices and matching criteria.

FIG. 6 is a flow diagram of an example method for improving transportation utilization.

FIG. 7 is an illustration of an example user interface for selecting a mode of transportation.

FIG. 8 is an illustration of an additional example user interface for selecting a mode of transportation.

FIG. 9 is an illustration of an example chart of transportation utilization for a constrained mode of transportation.

FIG. 10 is a block diagram of an example dynamic transportation matching system.

FIG. 11 is a flow diagram of an example method for improving transportation utilization.

FIG. 12 is an illustration of an example requestor/provider management environment.

FIG. 13 is an illustration of an example data collection and application management system.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to systems and methods for efficiently surfacing the availability of constrained transportation options, such as autonomous vehicles (AVs), in a manner that may partially or fully optimize utilization of those options and/or that may improve the experience of users, especially during high-demand periods of time. During high-demand times, requests for transportation with a high estimated arrival time and/or to a low-demand area may not be the most efficient matches for constrained transportation options, such as autonomous vehicles. Instead, waiting for a transportation request with a lower estimated arrival time and/or to a higher-demand area may be a better choice in terms of maximizing the percentage of time an autonomous vehicle spends transporting passengers and reducing the time passengers spend waiting for an autonomous vehicle. To this end, the systems and methods discussed herein may manage the types of transportation options presented to users for fulfilling transportation requests from the users dynamically altering the mode-availability radius (e.g., the radius within which the vehicle is available to be matched to a requestor device) of an autonomous vehicle may increase the utilization of the autonomous vehicle. In some embodiments, a dynamic transportation matching system may evaluate how fulfilling transportation requests with different modes of transportation may affect the utilization of those modes of transportation and may, in response to such a determination, decide how and/or whether to surface different options for fulfilling the request (e.g., by dynamically altering the mode-availability radius of an autonomous vehicle may increase the utilization of the autonomous vehicle).

As an example, a user may request, via a dynamic transportation matching system, transportation from an origin to a destination. In response, the dynamic transportation system may determine that the request is eligible to be fulfilled by at least two different modes of transportation. One of those modes may have a constraint associated with fulfilling the request (e.g., the mode may be an autonomous electric vehicle limited to servicing certain routes and/or limited to servicing destinations within certain ranges), and another mode may not have the same constraints (e.g., the other mode may be a human-operated, gas-powered vehicle that is not limited to the routes or ranges that constrain the autonomous electric vehicle).

Continuing with the previous example, after determining that the request may be eligible to be fulfilled by both constrained and unconstrained modes of transportation, the dynamic transportation matching system may calculate the expected impact that fulfilling the request via the constrained mode of transportation may have on the utilization of the constrained mode of transportation (e.g., a percentage of time that the autonomous electric vehicle spends fulfilling transportation requests). If the impact on the expected utilization satisfies a predetermined threshold (e.g., if fulfilling the request with the constrained mode would result in higher expected utilization than using the constrained mode to fulfill a different request), the dynamic transportation matching system may direct the user's device to present the constrained mode of transportation as an option for fulfilling the user's request for transportation. If the expected utilization does not satisfy the predetermined threshold (e.g., if fulfilling the request with the constrained mode would result in lower expected utilization of the constrained mode), the dynamic transportation matching system may not provide the user with the option of fulfilling the request with the constrained mode of transportation. In other words, in this example the dynamic transportation matching system may only allow the user to select the autonomous vehicle to fulfill the request for transportation if fulfilling the request is expected to optimize or maximize utilization of the autonomous vehicle. As explained in greater detail herein, the dynamic transportation system may also optimize utilization for different modes of transportation and/or may use a variety of different metrics and combinations of metrics to determine whether an expected impact of fulfilling a request with a constrained transportation mode meets a utilization threshold.

Accounting for the utilization of different modes of transportation may provide a variety of features and/or advantages over traditional matching methods in transportation matching systems. For example, embodiments presented herein may enhance a user's experience by only presenting the most efficient or effective modes of transportation to the user and may not overwhelm the user by providing the user with too many transportation options. Furthermore, by avoiding providing a user with inconvenient options, such as a vehicle that is far away from the user's current location, the systems presented herein may decrease user frustration.

Accounting for the utilization of different modes of transportation may also enable a transportation network to improve the efficiency of the utilization of various resources of the network. For example, during busy times, such as during rush hour, requests for transportation with a high estimated arrival time (ETA) and/or to a low-demand area may not be the most efficient matches for AVs. Instead, waiting for a request with a lower ETA and/or to a higher-demand area may be a better choice in terms of maximizing the percentage of time an AV spends transporting passengers, even if AV idle time is slightly increased. In other words, not every request that is eligible to be fulfilled by a constrained mode of transportation may be an efficient request for that constrained mode of transportation to fulfill. For example, a request for transportation to a destination in an area where new requests that can be fulfilled by an AV are unlikely may be less efficient for an AV to fulfill than a request for transportation to a destination that has many AV pickup zones and thus more opportunities for the AV to fulfill additional transportation requests in an efficient manner after completing the current request. Additionally, by matching constrained modes of transportation with high-efficiency requests, the systems described herein may improve additional metrics, such as resource usage (e.g., by consuming less fuel due to transportation providers traveling fewer miles), user satisfaction (e.g., by decreasing wait times, increasing option variety, etc.), and/or any other suitable metric.

In some embodiments, dynamically altering the mode-availability radius of an AV may increase the utilization of the AV. For example, during slow times an AV may be dispatched to any eligible transportation requestor within a ten-minute ETA (i.e., within ten minutes of transit time) while during busy times an AV may be dispatched to eligible transportation requestors within a four-minute ETA. In one embodiment, a dynamic transportation matching system may use machine-learning techniques to predict expected future requests near the location of the AV and/or the drop-off location of the request to determine whether to surface the AV option to a current request or not surface the AV option and wait for a request that will yield higher utilization and/or a better user experience. In some examples, the dynamic transportation matching system may calculate an expected value of a request (e.g., in terms of utilization, impact on user experience, and/or any other suitable metric) to determine whether to surface the AV option on the requestor device.

Furthermore, the systems and methods described herein may improve the functioning of a computer that matches transportation requestors with transportation providers by enabling the computer to improve the efficiency and/or calculations for matches. Furthermore, for the reasons mentioned above and to be discussed in greater detail below, the systems and methods described herein may provide advantages to transportation-matching services and systems by increasing the efficiency of dynamic transportation matching and/or enabling dynamic transportation matching systems to provide improved user experience.

As will be explained in greater detail below, a dynamic transportation matching system may arrange transportation on an on-demand and/or ad-hoc basis by, e.g., matching one or more transportation requestors and/or transportation requestor devices with one or more transportation providers and/or transportation provider devices. For example, a dynamic transportation matching system may match a transportation requestor to a transportation provider that operates within a dynamic transportation network (e.g., that is managed by, coordinated by, and/or drawn from by the dynamic transportation matching system to provide transportation to transportation requestors).

In some examples, available sources of transportation within a dynamic transportation network may include vehicles that are owned by an owner and/or operator of the dynamic transportation matching system. Additionally or alternatively, sources of transportation within a dynamic transportation network may include vehicles that are owned outside of the dynamic transportation network but that participate within the dynamic transportation network by agreement. In some examples, the dynamic transportation network may include lane-bound vehicles (e.g., cars, light trucks, etc.) that are primarily intended for operation on roads. Furthermore, the dynamic transportation network may include rideables such as personal mobility vehicles (PMVs) and/or micro-mobility vehicles (MMVs) that are not bound to traditional road lanes, such as scooters, bicycles, electric scooters, electric bicycles, and/or any other suitable type of PMV and/or MMV. In some embodiments, a dynamic transportation network may include AVs (e.g., self-driving cars) that may be capable of operating with little or no input from a human operator.

As noted, a dynamic transportation matching system may receive a request for transportation from a transportation requestor device and determine whether the request for transportation is eligible for transportation by a constrained mode of transportation. In some examples, the term “mode of transportation” may generally refer to a category of transportation provider that shares the same constraints and/or lack of constraints on a dynamic matching system or other transportation network. For example, a mode of transportation may refer to all AVs, AVs of a specific make, AVs of a specific model, AVs with a particular capability, AVs that are operated by a particular fleet operator and/or provider, non-AVs, non-AVs operated by operators with specific constraints and/or preferences, vehicles with a certain capacity (e.g., high-capacity vehicles with six or more seats, low-capacity vehicles with two or fewer seats, etc.), vehicles of a certain class (e.g., luxury vehicles), vehicles with specific limitations (e.g., electric vehicles with limited ranges), and/or vehicles with specific capabilities (e.g., off-road vehicles). In some examples, the term “mode of transportation” may refer to an instance of vehicle within a mode of transportation and/or class or category, such as a specific AV, non-AV, and/or other vehicle within a particular category of transportation provider as described above.

In some examples, the term “constrained mode of transportation” generally refers to a mode of transportation having at least one constraint that renders the constrained mode ineligible and/or unable to respond to one or more other transportation requests that an unconstrained mode is eligible and/or able to fulfill. In other words, a vehicle or other provider within a constrained mode of transportation may be limited or restricted such that the mode of transportation is not suitable for, or is not designated for, fulfilling every type of transportation request. For example, a vehicle within a particular mode may be incapable of taking a particular route, going to a particular pickup or drop-off location, may have insufficient number of seats, be too expensive to fulfill a request within a particular cost structure, and/or may have other constraints.

A constrained mode of transportation may be limited by one or more of a variety of different types of constraints. In some examples, a constrained mode of transportation may be a mode of transportation limited by one or more technical constraints, operator constraints, regulatory constraints, route constraints, range constraints, location-based constraints, environmental constraints, economic constraints, system-imposed constraints, and/or any other constraints that may limit the mode's eligibility to fulfill certain transportation requests. These constraints may limit a mode of transportation in a variety of ways.

A technical constraint of a mode of transportation may be any constraint associated with the mechanical and/or electrical operation of a vehicle. Technical constraints may include, without limitation, battery and/or gas tank size, passenger capacity, top speed, acceleration ability, physical size, navigational abilities, vehicle width, vehicle height, etc. For example, a technical constraint of an AV may be a battery size of the AV that limits a range of the AV, a limited top speed of an AV that limits the AV from taking routes with speed limits above the top speed, etc.

An operator constraint may be any constraint associated with an operator of a vehicle. Operator constraints may include driver preferences to operate in certain regions, to operate at certain times of day, to take trips in certain directions, to take trips of a certain distance and/or duration, to take trips to certain destinations, and/or any other driver-defined preference or constraint. For example, an operator preference may include a preference of a driver to operate only within a certain geographic area (e.g., a city), to fulfill only short range transportation requests, to fulfill particular types of transportation requests, etc.

A regulatory constraint may be any constraint imposed by a local government, a state government, a federal government, and/or by any other regulatory agency. A regulatory constraint may limit a mode of transportation to picking up passengers in predetermined zones, may limit a mode of transportation to operating in certain geographical areas, may limit drop-off locations where a mode of transportation is allowed to drop off passengers, may limit times of day a mode of transportation may operate, etc. For example, a regulatory constraint may limit an AV to operating only during the day (e.g., from sunup to sundown), may limit an AV to operating along particular routes or within particular predefined areas, etc.

A route constraint may be any constraint associated with routes a mode of transportation is allowed to take and/or areas in which a vehicle is capable of fulfilling transportation requests. Route constraints may be the result of regulatory constraints, technical constraints, and/or any other type of limitation that may restrict a mode of transportation from following a particular route and/or that may limit the mode of transportation to a particular route. A route constraint may limit a mode of transportation to operating on certain streets, to picking up or dropping off riders at particular locations, to following a particular route between an origin and a destination, to avoid certain roads or regions between an origin and destination, etc. For example, a route constraint may indicate that an AV should not take any route with ongoing roadwork.

A range constraint may be any constraint that limits the distance a vehicle is capable of traveling while fulfilling, traveling to, and/or traveling from transportation requests. Range constraints may be regulatory constraints, technical constraints, and/or any other type of constraint that may limit a mode of transportation to operating with limited range. A range constraint may be an inherent limitation of a vehicle, may be implemented to optimize the efficiency of an electric vehicle's battery usage, may be implemented to optimize the utilization of an AV, etc.

An environmental constraint may be any constraint caused by environmental conditions. Environmental conditions may include inclement weather (rain, snow, high winds, etc.), traffic conditions, road conditions, roadwork, etc. For example, an environmental condition may be a weather condition (e.g., fog) in a particular area that may limit the use of an AV in that area. As another example, an environmental condition might be road work along a route that would cause the route to be more suitably navigated by a vehicle operated by a human driver than by an autonomous vehicle.

A system-imposed constraint may be any constraint imposed on a particular mode of transportation by a dynamic transportation matching system. System-imposed constraints may be implemented to address constraints inherent in a particular mode of transportation (e.g., a system-imposed limitation on route distance for a range-limited electric vehicle) or may be independent of other types of constraints. In other words, while some system-imposed constraints may be inherent to or related to particular limitations of a mode of transportation, other system-imposed constraints may be applied to a mode of transportation based on other criteria (e.g., optimization of a utilization metric of the mode of transportation, optimization of driver experience, etc.). For example, even if a constrained mode of transportation (e.g., an AV) is capable of fulfilling a particular type of transportation request (e.g., a request to transport a rider outside of an area where AVs are in high demand), a system-imposed constraint may designate the constrained mode of transportation as being ineligible to fulfill the transportation request if another mode of transportation would be more suitable for fulfilling the request.

Some constraints may generally be categorized as AV constraints. As discussed, an AV may be a constrained mode of transportation because regulations and/or technical challenges may limit where the vehicle may be legally allowed to pick up and/or drop off passengers. Additionally or alternatively, an AV may be designated as a constrained mode of transportation because some requests may be better suited to being fulfilled by human-operated vehicles than by AVs. Furthermore, in some embodiments, AV constraints may be different for different types of AVs (e.g., different models and/or vehicles from different makers). For example, different AVs may have different range limitations, different navigational capabilities, different top speeds, etc.

In contrast with the term “constrained mode of transportation,” the term “unconstrained mode of transportation” generally refers to any mode of transportation that does not have the constraint of the constrained mode of transportation. In other words, a vehicle and/or provider within an unconstrained mode of transportation may be eligible to fulfill certain transportation requests while a vehicle or provider operating in the constrained mode may be ineligible to fulfill those certain transportation requests. For example, an unconstrained mode of transportation may not have one or more of the technical constraints, route constraints, range constraints, driver constraints, location-based constraints, regulatory constraints, environmental constraints, and/or other constraints that the constrained mode of transportation has. In some examples, an unconstrained mode of transportation may have no inherent constraints (e.g., as opposed to situational constraints such as being already occupied transporting transportation requestors) that prevent the mode of transportation from fulfilling a request for transportation.

In some embodiments, AVs may be generally categorized as constrained modes of transportation since they may be restricted to certain pickup locations, drop-off locations, routes, areas, etc., which may limit the ability of AVs to complete a request. Human-operated vehicles may be generally categorized as unconstrained modes of transportation because the human can operate the vehicle without those restrictions and/or because road networks are generally configured to allow human drivers to access the majority of the road networks. In such embodiments, a constraint that limits an availability and/or an ability of an AV to fulfill a particular request for transportation would not limit an availability and/or an ability of a human-operated vehicle to fulfill the request. For example, a dynamic transportation matching system may limit an AV to fulfilling requests to destinations within a certain area, and the system may allow human-operated vehicles to fulfill requests with destinations both inside and outside of that area.

Differentiating between constrained modes of transportation and unconstrained modes of transportation may be helpful to partially or fully optimize the utilization for certain modes of transportation. The term “utilization” may generally refer to any metric related to the time a mode of transportation is engaged in fulfilling a transportation request. In some embodiments, the utilization may refer to the time a mode of transportation spends transporting passengers as opposed to being engaged in other activities, such as traveling to meet passengers and/or waiting to be matched with a transportation requestor device. Additionally or alternatively, the utilization of a mode of transportation may be calculated to include traveling to and/or from passengers as part of fulfilling a transportation request. In some embodiments, the utilization may be expressed as a percentage of total time within a timespan (e.g., a day, a week, the time since the mode of transportation became operational, etc.) that a mode of transportation has spent transporting passengers and/or traveling to passenger pickup locations. Additionally or alternatively, the utilization may be a percentage of active time (e.g., time when the mode of transportation is participating in the dynamic transportation network as opposed to being offline, receiving maintenance, etc.) that the mode of transportation has spent transporting passengers.

A dynamic transportation matching system may use the expected impact (on the utilization of a constrained mode of transportation) of fulfilling a transportation request with a constrained mode of transportation to determine whether to surface the constrained mode of transportation as an option for fulfilling the transportation request. In other words, the dynamic transportation matching system may determine whether an expected impact satisfies a utilization threshold (e.g., a threshold indicating that impact would need to have a positive effect on the utilization). Then, the dynamic transportation matching system may direct a transportation requestor device to present the constrained mode as an option for fulfilling the request for transportation if the expected impact satisfies the utilization threshold.

The systems described herein may categorize and/or calculate various kinds of impacts on utilization. In some examples, an expected impact on utilization may be an expected change to the utilization (e.g., of a particular vehicle and/or a class of vehicle) as a result of transporting or not transporting a given transportation requestor. For example, an expected impact on the utilization of a mode of transportation may be positive (e.g., may increase the percentage of time the mode of transportation is expected to spend transporting a passenger), neutral (e.g., may not change the percentage of time the mode of transportation is expected to spend transporting a passenger), or negative (e.g., may lower the percentage of time the mode of transportation is expected to spend transporting the passenger). In some embodiments, expected impact may be represented as a percentage change to utilization (e.g., +3%, −0.02%, etc.), a time change to utilization (e.g., +5 minutes of utilized time, −10 minutes of utilized time, etc.), and/or any other suitable representation. In one example, if fulfilling an initial transportation request is expected to cause a mode of transportation to spend fifteen of the next thirty minutes transporting a passenger and the remaining time not transporting a passenger while fulfilling an alternative transportation request is expected to cause the mode of transportation to spend twenty of the next thirty minutes transporting a passenger, the alternative transportation request may have a more positive expected impact on the utilization of the mode of transportation than the initial transportation request.

The expected impact of fulfilling a transportation request may affect how the dynamic transportation matching system matches a requestor device with one or more different providers across one or more constrained or unconstrained modes. In some examples, it may be beneficial to a dynamic transportation network to not present the option to fulfill a transportation request via a constrained mode of transportation if another eligible request is likely to be received soon that may have more of a positive impact on the dynamic transportation network (e.g., in terms of utilization of the constrained mode of transportation, user experience, driver experience, etc.) if fulfilled by the constrained mode of transportation. Additionally or alternatively, it may be beneficial to a dynamic transportation network to not present the option to fulfill a transportation request via a constrained mode of transportation if fulfilling the request with another mode of transportation would have more of a positive impact on the dynamic transportation network (e.g., in terms of utilization of the constrained mode of transportation, user experience, driver experience, etc.).

The term “request for transportation,” “transportation request,” or “request,” as used herein, may generally refer to an indication that a user desires transportation between a starting location and a destination. In some examples, a request for transportation may be initiated by a user sending a message to a dynamic transportation matching system that specifies a starting location and/or destination. Additionally or alternatively, the systems described herein may identify a user initiating a session on a dynamic transportation application (e.g., opening the application) as a request for transportation. In some embodiments, the systems described herein may infer a starting location and/or destination of a transportation request without the information being explicitly provided by a user. For example, the systems described herein may infer that the current location of a user (e.g., as determined by a location sensor of a requestor device operated by the user) is a starting location. In another example, the systems described herein may use historical trip data for the user to determine a destination. For example, if a user frequently makes trips to the same destination at a certain time of day (e.g., to work at 9 A.M. and/or home at 5 P.M.), the systems described herein may infer the destination if the user initiates a session on the transportation application at that time of day. In some examples, the systems described herein may identify a transportation request in response to a user approaching a location from which the user frequently requests transportation (e.g., a particular street corner, a public transit hub, etc.). In one embodiment, the systems described herein may identify a request for transportation in response to a user taking a picture of a starting location for a transportation request. Although primarily described in terms of transporting one or more people, fulfilling a transportation request may additionally or alternatively include transporting animals and/or objects. For example, fulfilling a transportation request may include picking up an item at a starting location and delivering the item to a destination.

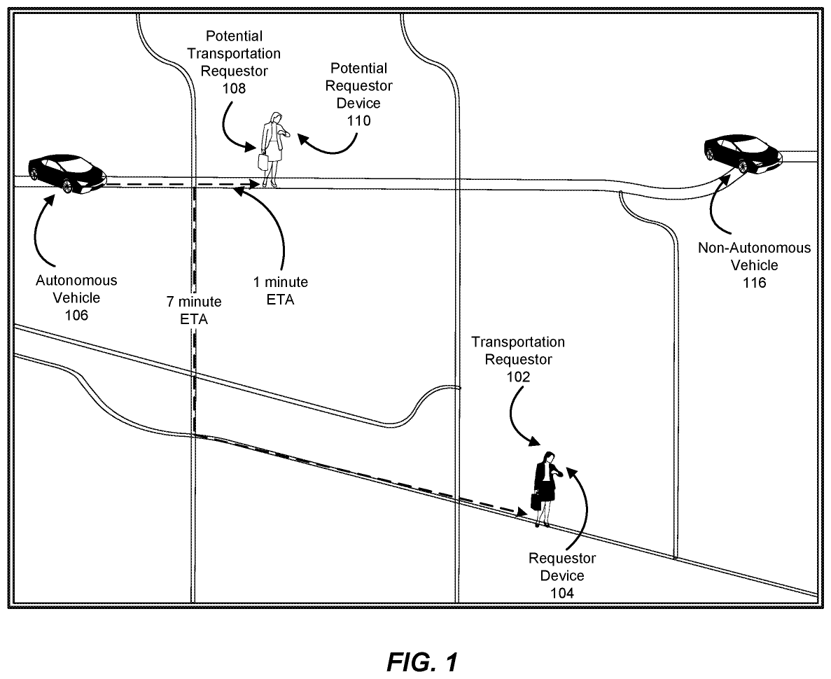

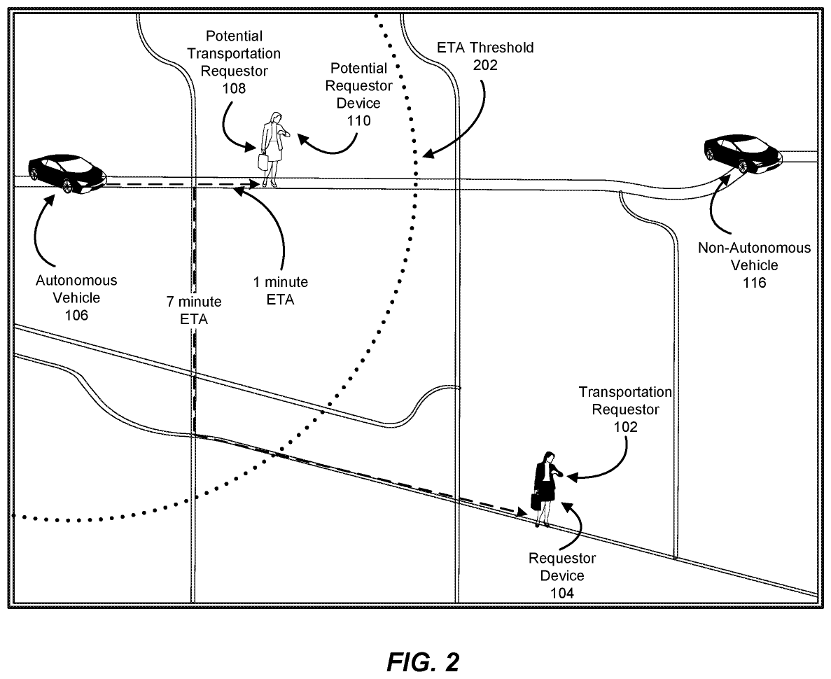

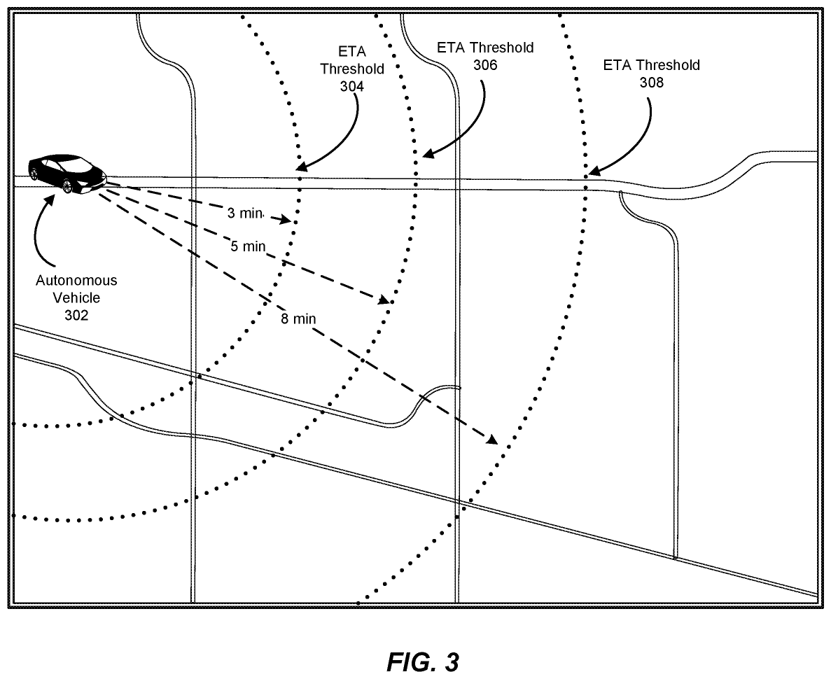

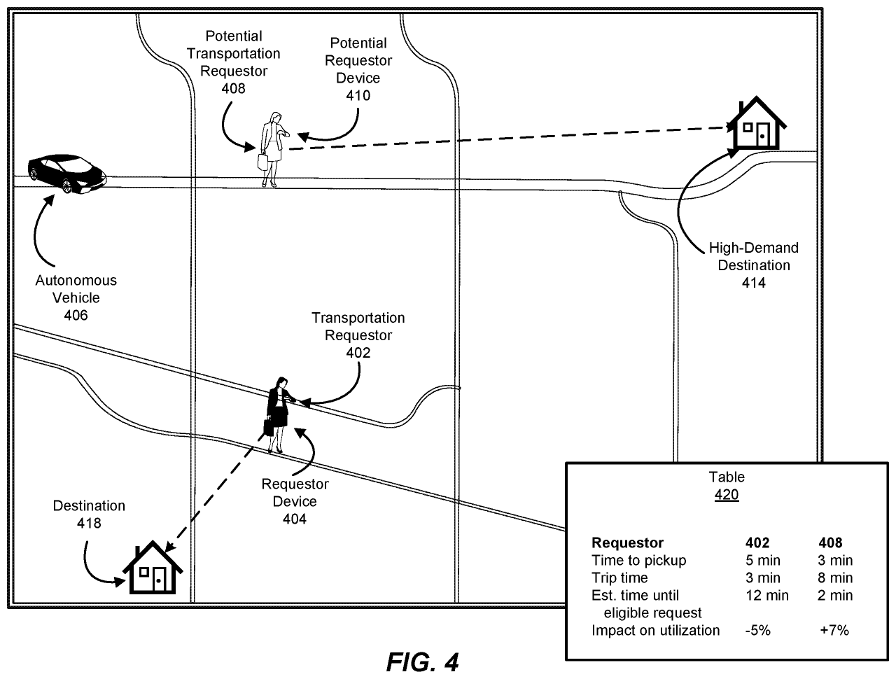

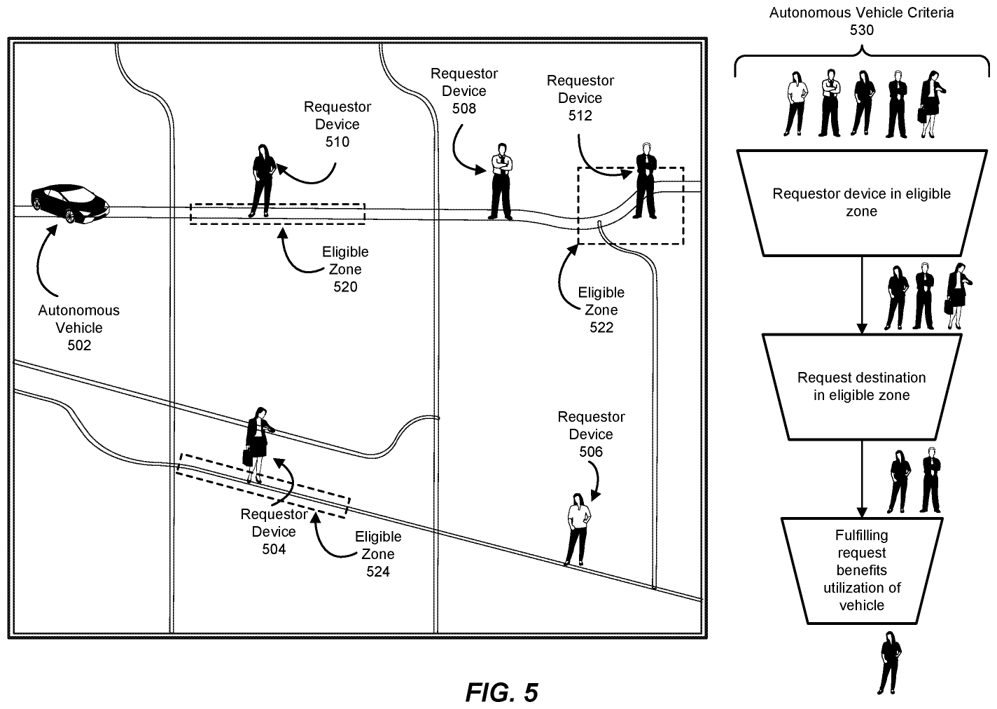

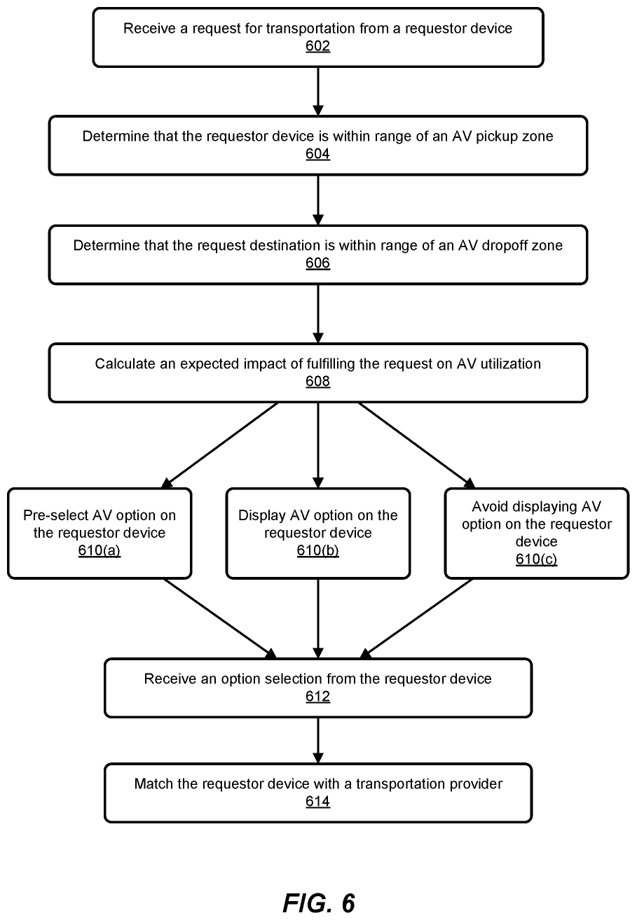

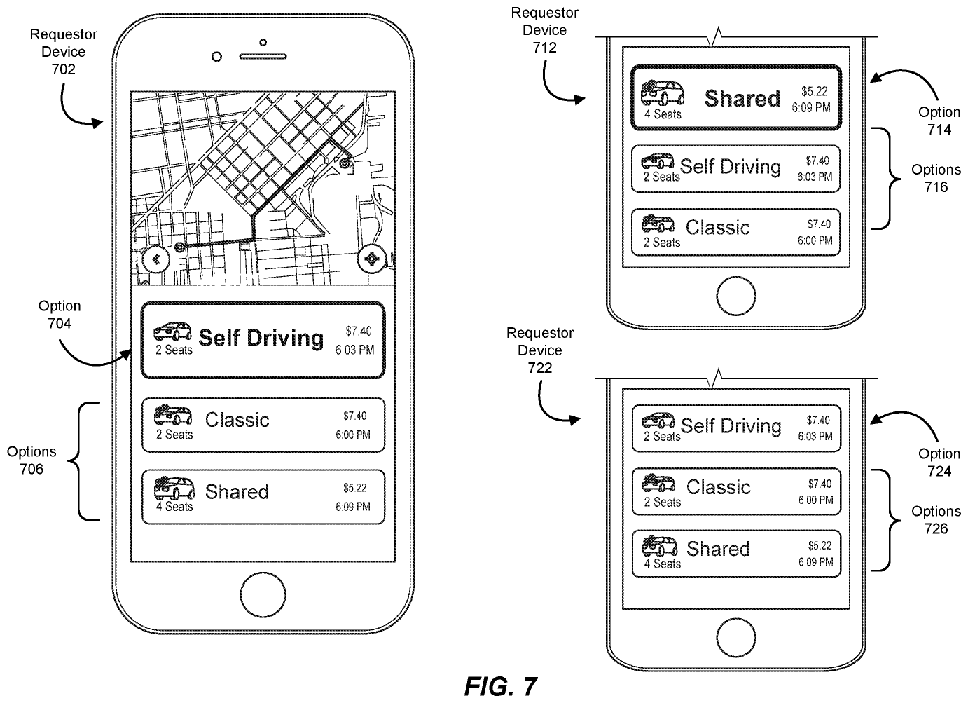

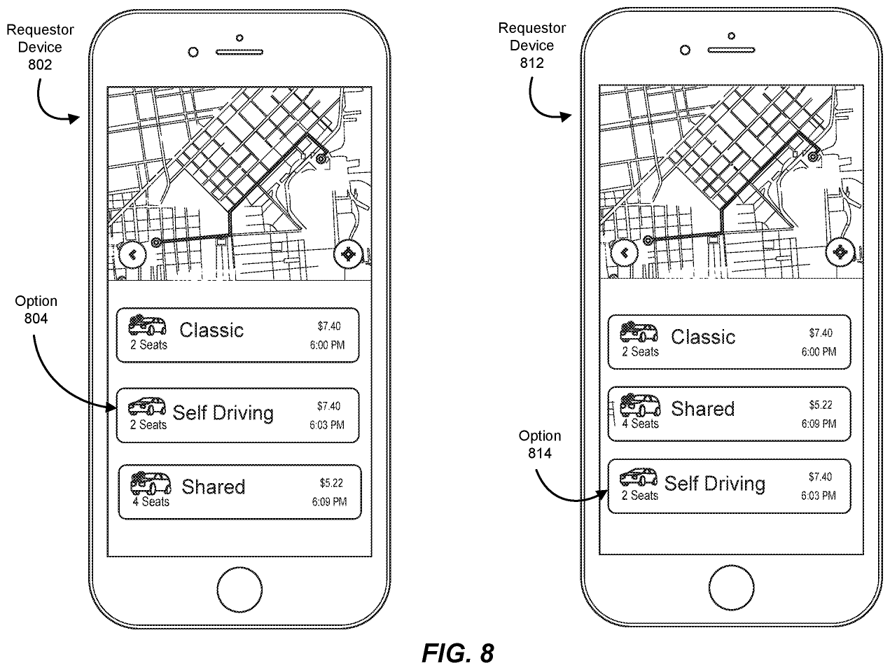

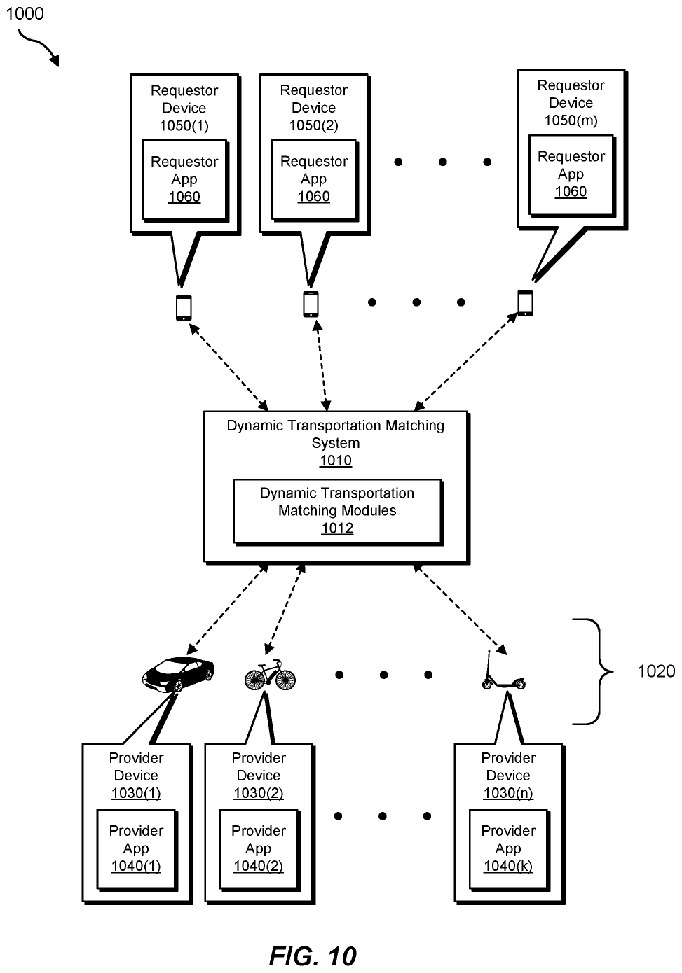

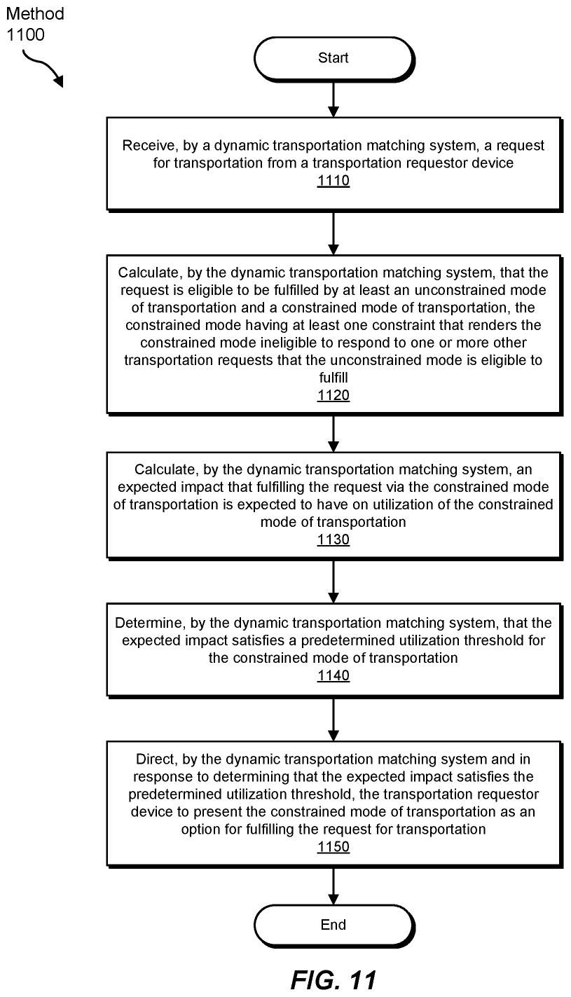

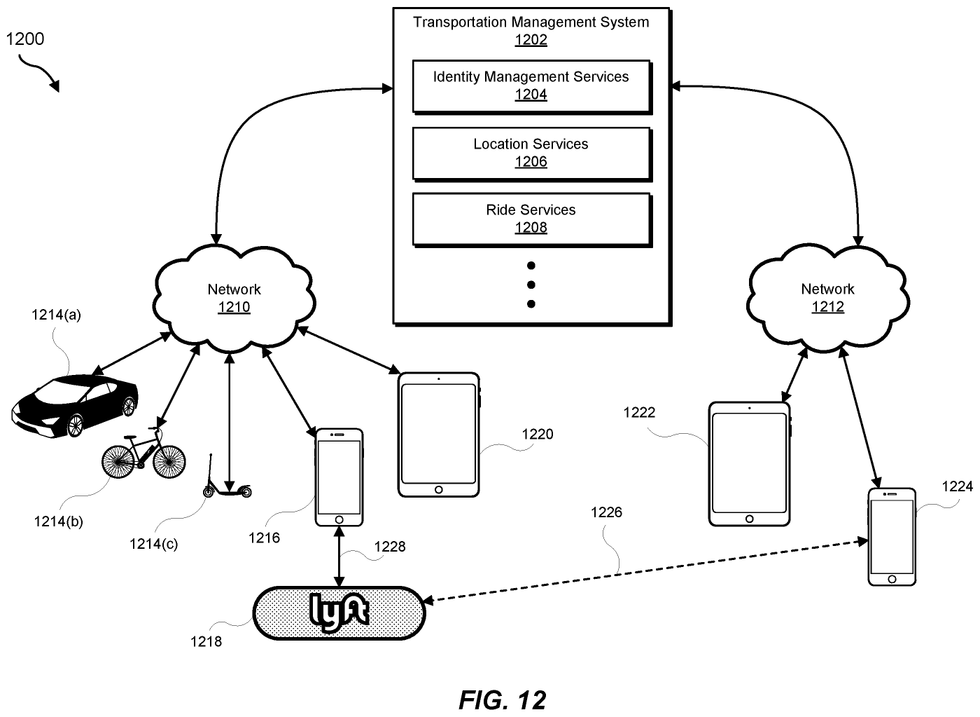

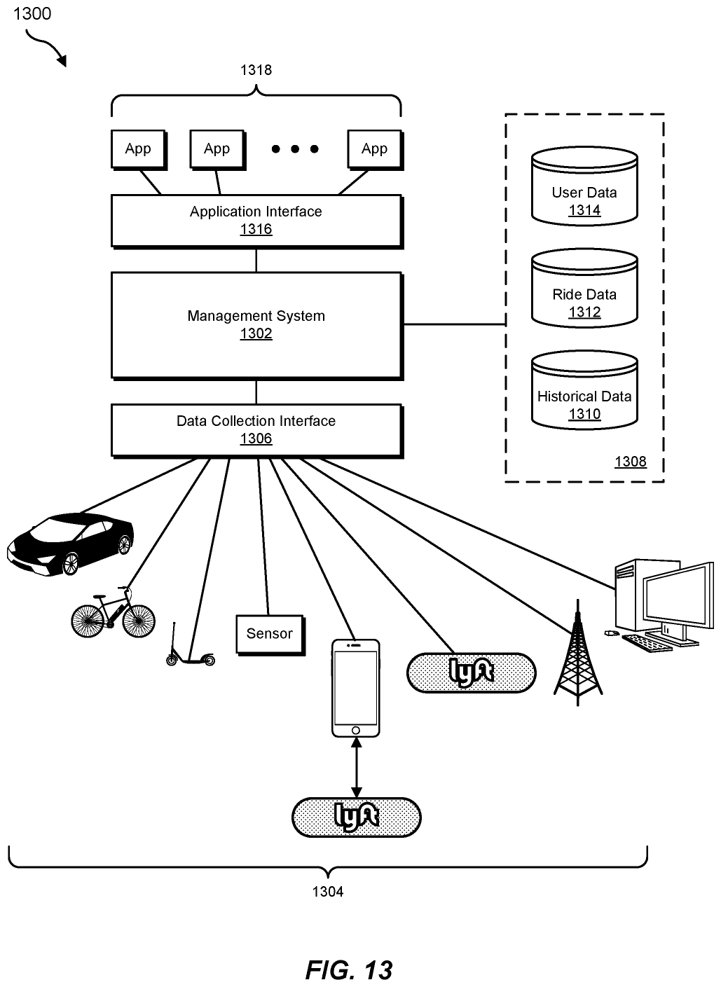

Turning to the figures, the discussion corresponding to FIGS. 1 and 2 provides examples of situations where a dynamic transportation matching system may determine whether to surface the option of fulfilling a request for transportation with a constrained mode of transportation. The discussion corresponding to FIGS. 3 and 4 explains how estimated arrival times and/or request destinations may be used to determine whether to surface an option for fulfilling a request for transportation with a constrained mode. The discussion corresponding to FIG. 5 explains how various matching criteria may be implemented, and the discussion corresponding to FIG. 6 provides an overview of an exemplary process for improving the utilization for a constrained mode of transportation. The discussion corresponding to FIGS. 7 and 8 explains how constrained modes of transportation may be displayed and/or highlighted on a transportation requestor device, and the discussion corresponding to FIGS. 7-9 explains how a dynamic transportation matching system may improve and/or optimize the utilization for constrained modes of transportation. The discussion corresponding to FIGS. 10 and 11 provides a summary of how a method of improving transportation utilization may be deployed in a dynamic transportation matching system, and the discussion corresponding to FIGS. 12 and 13 covers exemplary management environments and systems for dynamic transportation matching systems.

FIG. 1 illustrates an example transportation requestor 102 with a requestor device 104. In one example, requestor device 104 may send a request for transportation that may be eligible to be fulfilled by an AV 106 that is seven minutes away from requestor device 104. In one example, one minute after requestor device 104 sends the transportation request, a potential transportation requestor 108 who is only one minute away from AV 106 may send, via a potential requestor device 110, a request for transportation. In this example, it may be more efficient for AV 106 to fulfill a potential request from potential requestor device 110 and a nearby non-AV 116 to fulfill the request from requestor device 104. However, at the time the request from requestor device 104 is received, the dynamic transportation matching system may not yet have received the request from potential requestor device 110. As a result, the dynamic transportation matching system may determine, independent and/or in exclusion of information about potential requestor device 110, whether to match requestor device 104 with AV 106 or with non-AV 116. Determining whether to match AV 106 with requestor device 104 or wait for a potentially more efficient future request may be a complex problem that is further complicated by the constraints unique to AVs.

The systems described herein may use various strategies for efficiently dispatching AVs. In some embodiments, a mode-availability radius for a constrained mode of transportation may enable a dynamic transportation matching system to efficiently determine when to present an option for a constrained mode of transportation to a transportation requestor. In some examples, requests originating from requestor devices outside the mode-availability radius may have a very high probability of having a negative impact on utilization (e.g., due to high travel time to pick up the transportation requestor) and/or requests originating within the mode-availability radius may have a very high probability of having a positive impact on utilization (e.g., due to low travel time to pick up the transportation requestor), making a mode-availability radius an efficient heuristic for determining when to present the option for the constrained mode of transportation. For example, as illustrated in FIG. 2, a dynamic transportation matching system may set an ETA threshold 202 such that the dynamic transportation matching system will not present the option to match the constrained mode of transportation to any requestor device outside the threshold. In one example, requestor device 104 may be outside ETA threshold 202 and the dynamic transportation matching system may exclude the option to fulfill the transportation request via AV 106 from the set of options presented via requestor device 104. In this example, declining to match AV 106 with transportation requestor device 104 may leave AV 106 available to match with potential requestor device 110, which is within ETA threshold 202. In some embodiments, the mode-availability radius may be internal to the dynamic transportation matching system and may not be visible on requestor devices and/or provider devices.

In some embodiments, a dynamic transportation matching system may use a dynamic ETA threshold rather than a static ETA threshold to determine whether to offer eligible requestor devices the option to receive transportation from an AV or other constrained mode of transportation. For example, as illustrated in FIG. 3, during a time with high demand for AVs (e.g., rush hour, shortly after the end of a sporting event, etc.), a dynamic transportation matching system may only offer the option to receive transportation via an AV 302 to transportation requestor devices within an ETA threshold 304 of three minutes. In some examples, during less busy times, the dynamic transportation matching system may offer the option to match with AV 302 to transportation requestor devices within an ETA threshold 306 of five minutes. In one example, during the least busy times (e.g., the middle of the night), the dynamic transportation matching system may use an ETA threshold 308 of eight minutes. The ETA thresholds described in these examples are merely exemplary, and the systems described herein may use any other suitable ETA thresholds for determining whether to present a requestor with the option to use a constrained mode of transportation. Although illustrated as circles on a map, an ETA threshold may in reality be an irregular shape when viewed on a map due to road placement, traffic conditions, and/or other factors that affect the time it takes to traverse a distance.

While in some embodiments the systems described herein may rely solely on an ETA threshold to determine whether to offer eligible requestor devices the option to request transportation via an AV, in other embodiments, the systems described herein may use other methods in addition to and/or in place of ETA thresholds. For example, the systems described herein may predict future requests expected to be received from requestor devices in the vicinity (e.g., within several blocks, one mile, two miles, five miles, and/or ten miles, within corresponding ETA travel distances, etc.) of the AV to determine whether to direct the requestor device to display the option to select the AV.

Dynamic transportation matching systems may predict future requests in any suitable manner. In some embodiments, a dynamic transportation matching system may use historical data (e.g., requests received under similar circumstances, such as the time of day, day of week, weather, etc.) to predict future requests. The dynamic transportation matching system may use such historical data in a statistical analysis and/or to train a machine-learning model to predict when and where future requests may be received. Historical data may include information about requests that were received during a particular period of time and may include pick-up locations, drop-off locations, route information, information about the modes of transportation that fulfilled the requests, etc.

Dynamic transportation matching systems may implement any suitable type and/or form of statistical or machine learning model in predicting future requests. In some examples, a dynamic transportation matching system may implement time-series forecasting to predict information about future requests. Time-series forecasting may be implemented using an autoregressive model, a moving average model, an exponential smoothing model, and/or in any other suitable manner. In addition to such classical models, dynamic transportation matching systems may use historical data to train modern machine-learning models, such as decision trees, multilayer perceptrons, and/or long short-term memory network models.

In addition to or instead of using historical data to predict future requests, the systems described herein may use real-time metrics to predict future requests. Real-time metrics may include information about requests currently being received, information about devices currently issuing requests, information about the number and/or modes of transportation currently available to fulfill requests, the number of users with a ride-share application open on a mobile device, etc. For example, the systems described herein may predict a higher volume of near-future requests for an AV if one hundred devices with the application open are in the vicinity of the AV than if only ten devices with the application open are in the vicinity of the AV. As another example, if there are a low number of available transportation providers available in a certain area, the demand for a given transportation provider may be projected to be higher than if there are a high number of available transportation providers currently in the area.

The systems described herein may use a variety of algorithms to efficiently and effectively match constrained modes of transportation, such as AVs, with transportation requestors. In some embodiments, the systems described herein may calculate an expected value for the transportation request and compare the expected value to an expected value of the future demand. In some examples, the term “expected value” generally refers to the anticipated value an existing or anticipated transportation request may have to a transportation network. Expected value may calculated as a probability-weighted average of one or more possible outcomes (in terms of profitability, requestor satisfaction, transportation utilization, or any other value metric) of an existing or anticipated transportation request. In some examples, the expected value may represent an expected percentage change in the utilization of one or more modes of transportation, an expected change in utilization time, an expected change in monetary terms, and/or any other suitable metric and/or value. In some embodiments, the systems described herein may calculate the expected value for a particular vehicle and/or mode of transportation. Additionally or alternatively, the systems described herein may calculate the expected value for the dynamic transportation network as a whole.

In some embodiments, expected value may be calculated as the product of two metrics: (1) the value that fulfilling a transportation request via a particular transportation provider would produce (e.g., in terms of utilization time and/or percentage, monetary value, user experience metrics, and/or any other value metric) and (2) the likelihood (e.g., expressed as a percentage) that the particular provider will fulfill the transportation request. For example, a transportation request that has been received by the dynamic transportation matching system may have a high probability of being fulfilled while a potential transportation request predicted by the systems described herein may have a lower probability of being fulfilled due to the possibility that the potential request may not materialize (i.e., be received by the dynamic transportation matching system). In some embodiments, the systems described herein may calculate an expected value of predicted future demand by summing multiple potential future requests within a window of time (e.g., one minute, two minutes, five minutes, or ten minutes) after a set point in time (such as when a transportation request was received and/or when a transportation provider arrives at a destination). In some embodiments, the window of time may be a set window of time and may be for any suitable amount of time. Additionally or alternatively, the window of time may be calculated based on one or more other factors, such as the expected time the AV would spend fulfilling a transportation request if matched with the requestor device that sent the transportation request.

As mentioned, predicted future demand may be one of the factors (or the only factor) used to determine how to efficiently deploy constrained modes of transportation. In some examples, the term “future demand” may generally refer to requests for transportation expected and/or predicted to be received by the dynamic transportation matching system in a window of time that starts at the present time or later. Furthermore, in some embodiments, future demand may refer to requests that are expected to convert into completed trips (e.g., as opposed to requests cancelled before completion).

The systems described herein may use a future-demand prediction in a variety of ways. In some embodiments, a dynamic transportation matching system may compare the expected value of a current request to the expected value of future demand to determine whether to direct a requestor device to display an option for transportation via a constrained mode of transportation, such as an AV. If the expected value of the future demand is higher than the expected value of the current request, the transportation matching system may not direct the requestor device to display the option. If the expected value of the current request is higher than the expected value of the future demand, the transportation matching system may direct the requestor device to display the option. In some embodiments, if the expected value of the current request satisfies a threshold for high-expected-value requests (e.g., above a fixed value and/or a fixed amount above the expected value of the future demand), the systems described herein may direct the requestor device to display the option prominently, such as at the top of a list of options and/or as a highlighted option among other non-highlighted options.

A dynamic transportation matching system may predict future demand in a variety of ways and based on a variety of constraints. For example, a dynamic transportation matching system may predict future demand in the vicinity of the AV and/or in the vicinity of the destination of the transportation request. In some examples, a dynamic transportation matching system may predict future demand in the vicinity of the destination of the transportation request starting at the estimated arrival time of the AV at the destination. For example, as illustrated in FIG. 4, a transportation matching system may receive a transportation request from a requestor device 404 operated by a transportation requestor 402 for transportation to a destination 418. The transportation matching system may predict demand for an AV 406 at destination 418 after the estimated arrival time of AV 406 at destination 418 if AV 406 is selected to transport transportation requestor 402. In one example, the transportation matching system may predict that there is expected to be low demand in the vicinity of destination 418. As a result, rather than directing requestor device 404 to display the option to select transportation via AV 406, the transportation matching system may decline to direct requestor device 404 to display the option and may instead wait to match AV 406 with a potential future request to a higher-demand destination, such as a request from a potential requestor device 410 to transport a potential requestor 408 to high-demand destination 414. In some embodiments, factors including ETA, demand in destination vicinity, trip length, etc., may be dynamic factors, the combination of which may affect whether the systems described herein direct the requestor device to display the option for the constrained mode of transportation. For example, table 420 includes example ETAs, trip lengths, and estimated times until the next eligible request near each destination and the impact of those factors on the utilization. Because the expected impact of fulfilling a transportation request to transport requestor 402 is negative, the systems described herein may not direct requestor device 404 to display the option.

In some embodiments, a transportation matching system may determine whether a transportation request is eligible to be fulfilled by a constrained mode of transportation before determining whether to offer the constrained mode of transportation as an option for fulfilling the request. For example, as illustrated in FIG. 5, a dynamic transportation matching system may process a set of AV criteria 530 to determine whether to present the option to receive transportation via an AV to any given requestor device. In one example, the dynamic transportation matching system may receive requests for transportation from requestor devices 504, 506, 508, 510, and/or 512. In some examples, requestor devices 506 and/or 508 may not be in eligible zones (e.g., zones where an AV is permitted to pick up passengers). In one example, requestor device 510 may be in an eligible zone 520, requestor device 504 may be in an eligible zone 524, and/or requestor device 512 may be in an eligible zone 522. In some examples, the systems described herein may then determine whether requestor devices 504, 510, and/or 512 are requesting transportation to destinations that are in eligible zones (e.g., zones where an AV is permitted to drop off passengers). In one example, requestor device 504 may be requesting transportation to a destination that is not in an eligible zone while requestor devices 510 and/or 512 may be requesting transportation to eligible zones. The term “eligible zone,” as used herein, generally refers to any location where a constrained mode of transportation is eligible to pick up and/or drop-off a transportation requestor. For example, an eligible zone for an AV may be a zone where technology and/or regulations enable the AV to pick up and/or drop off passengers.

In some embodiments, a dynamic transportation matching system may compare the impact on the utilization of an AV 502 of fulfilling the transportation request from requestor device 510 and/or requestor device 512. In one example, the matching system may determine that the request from requestor device 510 has a more positive impact on the utilization than the request from requestor device 512 and, in response, may direct requestor device 510 to present the option to be transported by AV 502. Additionally or alternatively, the matching system may evaluate the requests from requestor device 510 and requestor device 512 independently of one another. In one example, the matching system may direct both requestor device 510 and requestor device 512 to present the option and may match AV 502 with whichever device selects the option first. In another example, the matching system may determine that the request from requestor device 510 sufficiently benefits the utilization of AV 502 to be directed to show the option while the request from requestor device 512 does not. Although illustrated as a linear process, in some embodiments, the systems described herein may evaluate AV criteria 530 in an alternate order (e.g., evaluating destination zone before pickup zone) and/or concurrently.

A dynamic transportation matching system may evaluate a transportation request in a variety of ways to determine whether to direct a requestor device to present an option for a constrained mode of transportation. For example, as illustrated in FIG. 6, at step 602 a transportation matching system may receive a request for transportation from a requestor device. In some examples, the request may include a current location of the requestor device and/or a destination of the request. At step 604, the transportation matching system may determine that the requestor device is in range of an AV pickup zone. For example, the requestor device may be within an AV pickup zone, within a reasonable walking distance (e.g., half a mile, a quarter mile, a five minute walk, etc.) of an AV pickup zone, and/or within a reasonable travel distance (e.g., via an available bicycle, scooter, and/or other rideable) of an AV pickup zone. At step 606, the transportation matching system may determine that the request destination is within range of an AV drop-off zone. For example, the request destination may be within an AV pickup zone, within a reasonable walking distance of an AV drop-off zone, and/or within a reasonable travel distance of an AV drop-off zone.

At step 608, the transportation matching system may determine an impact of fulfilling the request on AV utilization. For example, the transportation matching system may determine the expected transit time to the requestor device, the expected time transporting the transportation requestor would take, and/or the expected time it may take to receive another request after fulfilling the current request. The transportation matching system may then use one or more of these values to calculate the impact of fulfilling the request on AV utilization. In some examples, the systems described herein may calculate the impact on utilization by calculating the percentage of time that the AV spends actively transporting passengers, as opposed to traveling to passengers and/or waiting for requests for transportation. In some embodiments, the transportation matching system may categorize the impact on utilization. For example, the transportation matching system may categorize the impact as very positive, positive, neutral, or negative. Additionally or alternatively, the transportation matching system may evaluate whether the transportation request is of a type especially suited to AVs, such as a shared ride where multiple transportation requestors are picked up at different locations.

In one example, if the impact is very positive (e.g., above a predetermined threshold for positive impact on utilization), at step 610(a) the transportation matching system may pre-select the AV option on the requestor device. For example, the transportation matching system may direct the requestor device to display the option to request transportation via the AV at the top of a list of transportation options, as a highlighted option, and/or as a pre-selected option. In some examples, if the impact is somewhat positive (e.g., below a threshold for the highest category of positive impact but above a lower threshold), at step 610(b) the transportation matching system may display the AV option on the requestor device without drawing special attention to the option. For example, the transportation matching system may direct the requestor device to display the option alongside a list of other transportation options. In some examples, if the transportation matching system determines that the impact is neutral (e.g., is not positive and/or below a threshold for positivity and above a threshold for negativity) or negative (e.g., below a threshold for a neutral expected impact), at step 610(c) the transportation matching system may avoid displaying the AV option on the requestor device. For example, the transportation matching system may direct the requestor device to display a list of transportation options that does not include transportation via an AV. In some embodiments, the transportation matching system may determine the ETA of a non-AV to the requestor device and, if that ETA is above a threshold for high ETAs (e.g., greater than ten minutes, greater than fifteen minutes, greater than 30 minutes, etc.), may direct the requestor device to display the option to request transportation via an AV even if fulfilling the transportation request does not have a positive impact on the utilization of the AV. In some examples, at step 612, the transportation matching system may receive an option selection from the requestor device. For example, the transportation matching system may receive a selection of an AV or of a different mode of transportation, such as a non-AV. At step 614, the transportation matching system may match the requestor device with a transportation provider of a type that matches the selected option. For example, the transportation matching system may match the requestor device with an AV.

The systems described herein may present the option to select the constrained mode of transportation in different formats depending on the impact that fulfilling the request via the constrained mode of transportation would have on the utilization of the constrained mode of transportation. For example, as illustrated in FIG. 7, if the impact on the utilization of fulfilling a transportation request sent by a requestor device 702 is very positive, a transportation matching system may direct requestor device 702 to display option 704 to request transportation via an AV at the top of a list of other options 706. Similarly, if the constrained mode of transportation in question is shared transportation (e.g., a trip in which the transportation provider fulfills multiple transportation requests simultaneously), the systems described herein may direct a requestor device 712 to display option 714 to request shared transportation much more prominently than options 716 to request non-shared transportation. A transportation matching system may also highlight an option to use a constrained mode of transportation in any other suitable manner (e.g., by providing it as a pre-selected option, by making it larger than other options, and/or by otherwise displaying the option in a prominent fashion). However, if the impact on the utilization of fulfilling a transportation request sent by a requestor device 722 is only mildly positive, the systems described herein may direct requestor device 722 to display option 724 to request transportation via an AV in a similar fashion to how other options 726 are displayed, without option 724 being pre-selected, highlighted, or otherwise made more prominent than options 726.

In some embodiments, as illustrated in FIG. 8, an option 804 to select transportation via an AV may be displayed on a requestor device 802 amidst a list of other options without being prominently featured, placed at the top of a list, and/or otherwise highlighted. In one example, an option 814 to select transportation via an AV may be visually downplayed on a requestor device 812, for example by being at the end of a list of options, smaller than other options, in more muted colors, and/or in any other suitable way. In some embodiments, if the impact on the utilization of fulfilling a transportation request sent by a requestor device is mildly positive, neutral, or mildly negative, the systems described herein may direct the requestor device to display the option without any special prominence and/or in a less prominent position.

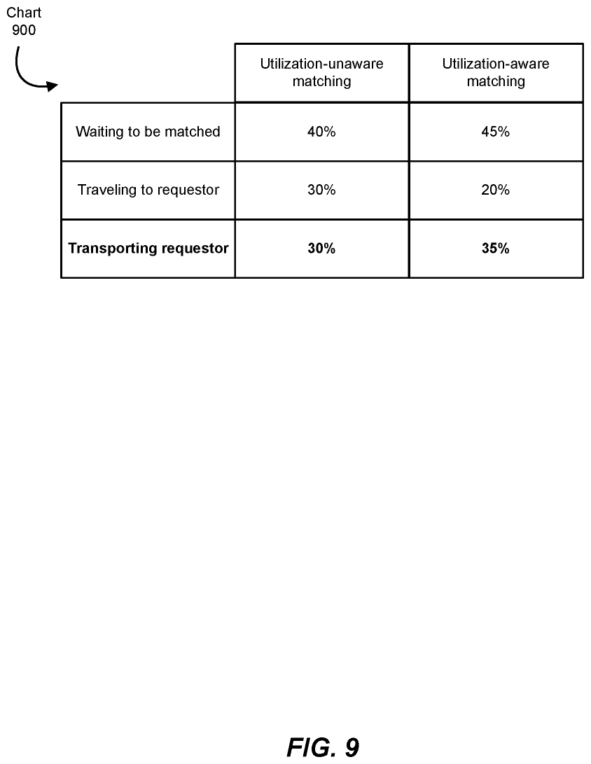

By determining whether and/or how to display the option to request transportation via an AV and/or other constrained mode of transportation, a transportation matching system may improve the overall utilization of a constrained mode of transportation. For example, as illustrated in chart 900 in FIG. 9, a mode of transportation that is matched with requestor devices via a non-utilization-aware method may spend 40% of its active time waiting to be matched, 30% of its active time traveling to a transportation requestor, and 30% of its active time transporting a transportation requestor. In some examples, this may be calculated as a utilization of 30%. However, if the systems described herein use utilization-aware matching to avoid displaying the option to match with the mode of transportation to transportation requestor devices that will yield insufficiently positive impacts on the utilization, the constrained mode of transportation may spend 45% of its active time waiting to be matched, 20% of its active time traveling to a transportation requestor, and 35% of its active time transporting a transportation requestor. In some examples, this may be a utilization of 35%. Although the mode of transportation may spend more time awaiting matching due to avoiding fulfilling some transportation requests, by selectively fulfilling transportation requests with a positive impact on utilization (e.g., from requestor devices with low ETAs), the mode of transportation may reduce time spent traveling to requestors, leading to an overall improvement in utilization. By reducing time spent traveling without transporting requestors, the systems described herein may reduce fuel or other resource consumption and/or wear on vehicles without negatively impacting user experience. All percentages in chart 900 are for illustrative purposes and the intelligent matching described herein may results in various other utilization numbers and/or advantages to dynamic transportation matching systems.

In some embodiments, a dynamic transportation matching system may include various modules that make determinations about which requestor devices to match with AVs and/or transportation providers of other types. FIG. 10 illustrates an example system 1000 for matching transportation requests with a dynamic transportation network that includes rideables and/or AVs. As shown in FIG. 10, a dynamic transportation matching system 1010 may be configured with one or more dynamic transportation matching modules 1012 that may perform one or more of the steps described herein. Dynamic transportation matching system 1010 may represent any computing system and/or set of computing systems capable of matching transportation requests. Dynamic transportation matching system 1010 may be in communication with computing devices in each of a group of vehicles 1020. Vehicles 1020 may represent any vehicles that may fulfill transportation requests and may be grouped and/or tracked as different modes of transportation with different types of constraints. In some examples, vehicles 1020 may include disparate vehicle types and/or models. For example, vehicles 1020 may include lane-bound vehicles and rideables. In some examples, some of vehicles 1020 may be standard commercially available vehicles. According to some examples, some of vehicles 1020 may be owned by separate individuals (e.g., transportation providers). Furthermore, while, in some examples, many or all of vehicles 1020 may be human-operated, in some examples many of vehicles 1020 may also be autonomous (or partly autonomous). Accordingly, throughout the instant disclosure, references to a “transportation provider” (or “provider”) may, where appropriate, refer to an operator of a human driven vehicle, an autonomous vehicle control system, an autonomous vehicle, an owner of an autonomous vehicle, an operator of an autonomous vehicle, an attendant of an autonomous vehicle, a vehicle piloted by a requestor, and/or an autonomous system for piloting a vehicle. While FIG. 10 does not specify the number of vehicles 1020, it may be readily appreciated that the systems described herein are applicable to hundreds of vehicles, thousands of vehicles, or more. In one example, dynamic transportation matching system 1010 may coordinate transportation matchings within a single region for 50,000 vehicles or more on a given day. In some examples, vehicles 1020 may collectively form a dynamic transportation network that may provide transportation supply on an on-demand basis to transportation requestors.

As mentioned above, dynamic transportation matching system 1010 may communicate with computing devices in each of vehicles 1020. The computing devices may be any suitable type of computing device. In some examples, one or more of the computing devices may be integrated into the respective vehicles 1020. In some examples, one or more of the computing devices may be mobile devices. For example, one or more of the computing devices may be smartphones. Additionally or alternatively, one or more of the computing devices may be tablet computers, personal digital assistants, or any other type or form of mobile computing device. According to some examples, one or more of the computing devices may include wearable computing devices (e.g., a driver-wearable computing device), such as smart glasses, smart watches, etc. In some examples, one or more of the computing devices may be devices suitable for temporarily mounting in a vehicle (e.g., for use by a requestor and/or provider for a transportation matching application, a navigation application, and/or any other application suited for the use of requestors and/or providers). Additionally or alternatively, one or more of the computing devices may be devices suitable for installing in a vehicle and/or may be a vehicle's computer that has a transportation management system application installed on the computer in order to provide transportation services to transportation requestors and/or communicate with dynamic transportation matching system 1010.

As shown in FIG. 10, vehicles 1020 may include provider devices 1030(1)-(n) (e.g., whether integrated into the vehicle, permanently affixed to the vehicle, temporarily affixed to the vehicle, worn by a driver of the vehicle, etc.). In some examples, provider devices 1030 may include a provider apps 1040(1)-(k). Provider apps 1040(1)-(k) may represent any application, program, and/or module that may provide one or more services related to operating a vehicle and/or providing transportation matching services. For example, provider apps 1040(1)-(k) may include a transportation matching application for providers and/or one or more applications for matching MMVs with requestor devices. In some embodiments, different types of provider vehicles may be provisioned with different types of provider devices and/or different provider applications. For example, MMVs may be provisioned with provider devices that are configured with a provider application that enables transportation requestors to reserve and/or operate the MMVs while road-constrained and/or lane-bound vehicles (e.g., cars) may be provisioned with provider devices that are configured with a provider application that enables provider vehicle operators (e.g., transportation providers) to respond to requests from transportation requestors. In some examples, provider applications 1040(1)-(k) may match the user of provider apps 1040(1)-(k) (e.g., a transportation provider) with transportation requestors through communication with dynamic transportation matching system 1010. In addition, and as is described in greater detail below, provider apps 1040(1)-(k) may provide dynamic transportation matching system 1010 with information about a provider (including, e.g., the current location of the provider and/or vehicle) to enable dynamic transportation matching system 1010 to provide dynamic transportation matching and/or management services for the provider and one or more requestors. In some examples, provider apps 1040(1)-(k) may coordinate communications and/or a payment between a requestor and a provider. According to some embodiments, provider apps 1040(1)-(k) may provide a map service, a navigation service, a traffic notification service, and/or a geolocation service.

Additionally, as shown in FIG. 10, dynamic transportation matching system 1010 may communicate with requestor devices 1050(1)-(m). In some examples, requestor devices 1050 may include a requestor app 1060. Requestor app 1060 may represent any application, program, and/or module that may provide one or more services related to requesting transportation matching services. For example, requestor app 1060 may include a transportation matching application for requestors. In some examples, requestor app 1060 may match the user of requestor app 1060 (e.g., a transportation requestor) with transportation providers through communication with dynamic transportation matching system 1010. In addition, and as is described in greater detail below, requestor app 1060 may provide dynamic transportation matching system 1010 with information about a requestor (including, e.g., the current location of the requestor) to enable dynamic transportation matching system 1010 to provide dynamic transportation matching services for the requestor and one or more providers. In some examples, requestor app 1060 may coordinate communications and/or a payment between a requestor and a provider. According to some embodiments, requestor app 1060 may provide a map service, a navigation service, a traffic notification service, and/or a geolocation service.

Embodiments of the instant disclosure may include or be implemented in conjunction with a dynamic transportation matching system. A transportation matching system may arrange transportation on an on-demand and/or ad-hoc basis by, e.g., matching one or more transportation requestors with one or more transportation providers. For example, a transportation matching system may provide one or more transportation matching services for a networked transportation service, a ridesourcing service, a taxicab service, a car-booking service, an autonomous vehicle service, a personal mobility vehicle service, a micro-mobility service, or some combination and/or derivative thereof. The transportation matching system may include and/or interface with any of a variety of subsystems that may implement, support, and/or improve a transportation matching service. For example, the transportation matching system may include a matching system (e.g., that matches requestors to ride opportunities and/or that arranges for requestors and/or providers to meet), a mapping system, a navigation system (e.g., to help a provider reach a requestor, to help a requestor reach a provider, and/or to help a provider reach a destination), a reputation system (e.g., to rate and/or gauge the trustworthiness of a requestor and/or a provider), a payment system, and/or an autonomous or semi-autonomous driving system. The transportation matching system may be implemented on various platforms, including a requestor-owned mobile device, a computing system installed in a vehicle, a requestor-owned mobile device, a server computer system, or any other hardware platform capable of providing transportation matching services to one or more requestors and/or providers.

While various examples provided herein relate to transportation, embodiments of the instant disclosure may include or be implemented in conjunction with a dynamic matching system applied to one or more services instead of and/or in addition to transportation services. For example, embodiments described herein may be used to match service providers with service requestors for any service.

FIG. 11 illustrates an example computer-implemented method 1100 for improving transportation utilization within a dynamic transportation matching system, such as dynamic transportation matching system 1010. As shown in FIG. 11, at step 1110, a dynamic transportation matching system may receive a request for transportation from a transportation requestor device. The dynamic transportation matching system may receive any suitable type of request for transportation in any suitable manner.

At step 1120, the dynamic transportation matching system may determine that the request is eligible to be fulfilled by at least an unconstrained mode of transportation and a constrained mode of transportation. The dynamic transportation matching system may determine that the request is eligible to be fulfilled by the constrained mode of transportation in any suitable manner. For example, the dynamic transportation matching system may determine that the requestor is in a pickup location eligible for pickup by the constrained mode of transportation, that a route to the destination is eligible to be traversed by the constrained mode of transportation, and/or that a destination of the request is eligible for drop-off by the constrained mode of transportation.

Similarly, the dynamic transportation matching system may determine that the request is eligible to be fulfilled by the unconstrained mode of transportation in any suitable manner. For example, the dynamic transportation matching system may determine that the request is eligible to be fulfilled by the unconstrained mode of transportation by determining that the unconstrained mode of transportation is within a predefined distance of the requestor.

The dynamic transportation matching system may differentiate the constrained mode of transportation from the unconstrained mode of transportation in any suitable way. For example, the dynamic transportation matching system may determine that the constrained mode of transportation is constrained because it is an AV and that the unconstrained mode of transportation is a human-operated vehicle. The dynamic transportation matching system may determine that, as an AV, the constrained mode of transportation is ineligible to respond to one or more other transportation requests that the unconstrained mode, as a human-operated vehicle, is eligible to fulfill.

At step 1130, the dynamic transportation matching system may calculate an expected impact that fulfilling the request via the constrained mode of transportation is expected to have on the utilization of the constrained mode of transportation. The dynamic transportation matching system may calculate the expected impact in any suitable manner. In some examples, the dynamic transportation matching system may calculate the expected impact by predicting a future demand expected to be received for the constrained mode of transportation during a window of time after the request for transportation was received. The dynamic transportation matching system may calculate the future demand expected to be received for the constrained mode of transportation by at least one of (1) calculating a future demand for the constrained mode of transportation around a location of the constrained mode of transportation and/or (2) calculating a future demand for the constrained mode of transportation around a destination of the request for transportation after an expected arrival time of the constrained mode of transportation at the destination.

In one embodiment, the dynamic transportation matching system may calculate the expected impact that fulfilling the request via the constrained mode of transportation is expected to have on the utilization of the constrained mode of transportation by (i) predicting an expected value of fulfilling the request via the constrained mode of transportation, (ii) predicting an expected value of the future demand for the constrained mode of transportation, and (iii) comparing the expected value of fulfilling the request for transportation via the constrained mode of transportation with the expected value of the future demand for the constrained mode of transportation. In this embodiment, directing the transportation requestor device to present the constrained mode of transportation may be performed in response to determining that the expected value of fulfilling the request for transportation is greater than the expected value of the future demand.

In some examples, the dynamic transportation matching system may calculate the future demand for the constrained mode of transportation by providing historical data about demand for the constrained mode of transportation around a location of the constrained mode of transportation as input to a machine-learning algorithm that predicts the future demand. The dynamic transportation matching system may then use the machine-learning algorithm to predict the future demand around the location for the window of time after the request for transportation was received. In some examples, the dynamic transportation matching system may calculate the future demand expected to be received for the constrained mode of transportation by predicting an expected wait time for receiving a potential future request that is eligible to be fulfilled by the constrained mode of transportation.

The term “expected wait time” may generally refer to a measurement of time between a starting point in time and a point in time at which the dynamic transportation matching system receives a transportation request that meets certain criteria. For example, an expected wait time may be the time between when the systems described herein determine not to match a particular AV with a transportation request and the time when the systems described herein receive an additional request that the AV is eligible to fulfill. In another example, an expected wait time may be the time between an AV dropping off a passenger and the dynamic transportation matching system receiving a request for transportation from an eligible requestor near the AV. In some embodiments, the systems described herein may calculate an expected wait time based on real-time conditions (e.g., number of current requestors) and/or historical data (e.g., previous requests under similar conditions). In some examples, an expected wait time may be two minutes, five minutes, eight minutes, and/or any other suitable period of time.

In one embodiment, the utilization of the constrained mode of transportation may be a percentage of time that the mode of transportation is transporting a transportation requestor. In some embodiments, the systems described herein may calculate the expected impact by calculating an ETA of the constrained mode of transportation at a location of the transportation requestor device. In some examples, the systems described herein may direct the transportation requestor device to present the constrained mode of transportation as an option for fulfilling the request in response to determining that the ETA of the constrained mode of transportation at the location of the transportation requestor device is below a predetermined threshold for the ETA.

At step 1140, a dynamic transportation matching system may determine that the expected impact on the utilization satisfies a predetermined utilization threshold for the constrained mode of transportation. In some embodiments, the term “predetermined utilization threshold” generally refers to any standard against which a transportation matching system may measure an impact on utilization. In some examples, a predetermined utilization threshold may be fixed. In other examples, a predetermined utilization threshold may vary based on circumstances. For example, a dynamic transportation matching system may raise the threshold during times with high demand for the constrained mode of transportation and/or lower the threshold during times with low demand. In one embodiment, a predetermined utilization threshold may be a percentage impact on the utilization, such as +10%, +5%, or +3%. In some embodiments, the systems described herein may have multiple predetermined utilization thresholds and/or may sort transportation requests into different categories based on which predetermined utilization threshold or thresholds would be satisfied by fulfilling the transportation request. For example, a dynamic transportation matching system may direct a requestor device associated with a transportation request that would fulfill the highest utilization threshold to display the option to select the constrained mode of transportation very prominently while another requestor device associated with a transportation request that satisfies only the lowest utilization threshold may be directed to display the option less prominently.

At step 1150, a dynamic transportation matching system may, in response to determining that the expected impact satisfies the predetermined utilization threshold, direct the transportation requestor device to present the constrained mode of transportation as an option for fulfilling the request for transportation. In one embodiment, the dynamic transportation matching system may direct, based on the expected impact, the transportation requestor device to present the constrained mode of transportation as the option for fulfilling the request for transportation by selecting a format for presenting the option that is correlated with the expected impact of fulfilling the request via the constrained mode of transportation and directing the transportation requestor device to present the option in the selected format.

In one example, the dynamic transportation matching system may (i) receive an additional request for transportation from an additional transportation requestor device, (ii) determine that the additional request is eligible to be fulfilled by both the unconstrained mode of transportation and the constrained mode of transportation, and (iii) calculate an additional expected impact that fulfilling the additional request via the constrained mode of transportation is expected to have on the utilization of the constrained mode of transportation. In this example, directing the transportation requestor device to present the constrained mode of transportation as an option for fulfilling the request for transportation may include determining to exclude the constrained mode of transportation as an option for fulfilling the additional request for transportation. For example, the systems described herein may receive a request from a transportation requestor, determine that the requestor is requesting transportation from an eligible zone for pickup to an eligible zone for drop-off, and then determine that the impact of fulfilling the transportation request via an AV is negative. For example, the transportation requestor may be relatively far away from the nearest AV, leading to un-utilized time on the way to pick up the requestor and/or the destination may be in a place with few eligible requests, leading to un-utilized time waiting for a new request after fulfilling the request. In this example, the systems described herein may not direct the requestor device to display the option to select an AV as a mode of transportation and may instead display other options, such as classic transportation, shared transportation, and/or luxury transportation.

Although described in terms of transportation requests within a dynamic transportation matching system, in some embodiments, the systems described herein may fulfill requests for any types of services. In some embodiments, the systems described herein may fulfill requests made via any type of request platform that includes one or more constrained modes of fulfilling a request and one or more unconstrained modes of fulfilling a request.

FIG. 12 shows a transportation management environment 1200, in accordance with various embodiments. As shown in FIG. 12, a transportation management system 1202 may run one or more services and/or software applications, including identity management services 1204, location services 1206, ride services 1208, and/or other services. Although FIG. 12 shows a certain number of services provided by transportation management system 1202, more or fewer services may be provided in various implementations. In addition, although FIG. 12 shows these services as being provided by transportation management system 1202, all or a portion of any of the services may be processed in a distributed fashion. For example, computations associated with a service task may be performed by a combination of transportation management system 1202 (including any number of servers, databases, etc.), one or more devices associated with a provider (e.g., devices integrated with managed vehicles 1214(a), 1214(b), and/or 1214(c); provider computing devices 1216 and tablets 1220; and transportation management vehicle devices 1218), and/or more or more devices associated with a ride requestor (e.g., the requestor's computing devices 1224 and tablets 1222). In some embodiments, transportation management system 1202 may include one or more general purpose computers, server computers, clustered computing systems, cloud-based computing systems, and/or any other computing systems or arrangements of computing systems. Transportation management system 1202 may be configured to run any or all of the services and/or software components described herein. In some embodiments, the transportation management system 1202 may include an appropriate operating system and/or various server applications, such as web servers capable of handling hypertext transport protocol (HTTP) requests, file transfer protocol (FTP) servers, database servers, etc.

In some embodiments, identity management services 1204 may be configured to perform authorization services for requestors and providers and/or manage their interactions and/or data with transportation management system 1202. This may include, e.g., authenticating the identity of providers and determining that they are authorized to provide services through transportation management system 1202. Similarly, requestors' identities may be authenticated to determine whether they are authorized to receive the requested services through transportation management system 1202. Identity management services 1204 may also manage and/or control access to provider and/or requestor data maintained by transportation management system 1202, such as driving and/or ride histories, vehicle data, personal data, preferences, usage patterns as a ride provider and/or as a ride requestor, profile pictures, linked third-party accounts (e.g., credentials for music and/or entertainment services, social-networking systems, calendar systems, task-management systems, etc.) and any other associated information. Transportation management system 1202 may also manage and/or control access to provider and/or requestor data stored with and/or obtained from third-party systems. For example, a requester or provider may grant transportation management system 1202 access to a third-party email, calendar, or task management system (e.g., via the user's credentials). As another example, a requestor or provider may grant, through a mobile device (e.g., 1216, 1220, 1222, or 1224), a transportation application associated with transportation management system 1202 access to data provided by other applications installed on the mobile device. In some examples, such data may be processed on the client and/or uploaded to transportation management system 1202 for processing.

In some embodiments, transportation management system 1202 may provide ride services 1208, which may include ride matching and/or management services to connect a requestor to a provider. For example, after identity management services 1204 has authenticated the identity a ride requestor, ride services 1208 may attempt to match the requestor with one or more ride providers. In some embodiments, ride services 1208 may identify an appropriate provider using location data obtained from location services 1206. Ride services 1208 may use the location data to identify providers who are geographically close to the requestor (e.g., within a certain threshold distance or travel time) and/or who are otherwise a good match with the requestor. Ride services 1208 may implement matching algorithms that score providers based on, e.g., preferences of providers and requestors; vehicle features, amenities, condition, and/or status; providers' preferred general travel direction and/or route, range of travel, and/or availability; requestors' origination and destination locations, time constraints, and/or vehicle feature needs; and any other pertinent information for matching requestors with providers. In some embodiments, ride services 1208 may use rule-based algorithms and/or machine-learning models for matching requestors and providers.

Transportation management system 1202 may communicatively connect to various devices through networks 1210 and/or 1212. Networks 1210 and 1212 may include any combination of interconnected networks configured to send and/or receive data communications using various communication protocols and transmission technologies. In some embodiments, networks 1210 and/or 1212 may include local area networks (LANs), wide-area networks (WANs), and/or the Internet, and may support communication protocols such as transmission control protocol/Internet protocol (TCP/IP), Internet packet exchange (IPX), systems network architecture (SNA), and/or any other suitable network protocols. In some embodiments, data may be transmitted through networks 1210 and/or 1212 using a mobile network (such as a mobile telephone network, cellular network, satellite network, or other mobile network), a public switched telephone network (PSTN), wired communication protocols (e.g., Universal Serial Bus (USB), Controller Area Network (CAN)), and/or wireless communication protocols (e.g., wireless LAN (WLAN) technologies implementing the IEEE 1002.12 family of standards, Bluetooth, Bluetooth Low Energy, Near Field Communication (NFC), Z-Wave, and ZigBee). In various embodiments, networks 1210 and/or 1212 may include any combination of networks described herein or any other type of network capable of facilitating communication across networks 1210 and/or 1212.

In some embodiments, transportation management vehicle device 1218 may include a provider communication device configured to communicate with users, such as drivers, passengers, pedestrians, and/or other users. In some embodiments, transportation management vehicle device 1218 may communicate directly with transportation management system 1202 or through another provider computing device, such as provider computing device 1216. In some embodiments, a requestor computing device (e.g., device 1224) may communicate via a connection 1226 directly with transportation management vehicle device 1218 via a communication channel and/or connection, such as a peer-to-peer connection, Bluetooth connection, NFC connection, ad hoc wireless network, and/or any other communication channel or connection. Although FIG. 12 shows particular devices communicating with transportation management system 1202 over networks 1210 and 1212, in various embodiments, transportation management system 1202 may expose an interface, such as an application programming interface (API) or service provider interface (SPI) to enable various third parties which may serve as an intermediary between end users and transportation management system 1202.

In some embodiments, devices within a vehicle may be interconnected. For example, any combination of the following may be communicatively connected: vehicle 1214, provider computing device 1216, provider tablet 1220, transportation management vehicle device 1218, requestor computing device 1224, requestor tablet 1222, and any other device (e.g., smart watch, smart tags, etc.). For example, transportation management vehicle device 1218 may be communicatively connected to provider computing device 1216 and/or requestor computing device 1224. Transportation management vehicle device 1218 may establish communicative connections, such as connections 1226 and 1228, to those devices via any suitable communication technology, including, e.g., WLAN technologies implementing the IEEE 1002.12 family of standards, Bluetooth, Bluetooth Low Energy, NFC, Z-Wave, ZigBee, and any other suitable short-range wireless communication technology.

In some embodiments, users may utilize and interface with one or more services provided by the transportation management system 1202 using applications executing on their respective computing devices (e.g., 1216, 1218, 1220, and/or a computing device integrated within vehicle 1214), which may include mobile devices (e.g., an iPhone®, an iPad®, mobile telephone, tablet computer, a personal digital assistant (PDA)), laptops, wearable devices (e.g., smart watch, smart glasses, head mounted displays, etc.), thin client devices, gaming consoles, and any other computing devices. In some embodiments, vehicle 1214 may include a vehicle-integrated computing device, such as a vehicle navigation system, or other computing device integrated with the vehicle itself, such as the management system of an autonomous vehicle. The computing device may run on any suitable operating systems, such as Android®, iOS®, macOS®, Windows®, Linux®, UNIX®, or UNIX®-based or Linux®-based operating systems, or other operating systems. The computing device may further be configured to send and receive data over the Internet, short message service (SMS), email, and various other messaging applications and/or communication protocols. In some embodiments, one or more software applications may be installed on the computing device of a provider or requestor, including an application associated with transportation management system 1202. The transportation application may, for example, be distributed by an entity associated with the transportation management system via any distribution channel, such as an online source from which applications may be downloaded. Additional third-party applications unassociated with the transportation management system may also be installed on the computing device. In some embodiments, the transportation application may communicate or share data and resources with one or more of the installed third-party applications.

FIG. 13 shows a data collection and application management environment 1300, in accordance with various embodiments. As shown in FIG. 13, management system 1302 may be configured to collect data from various data collection devices 1304 through a data collection interface 1306. As discussed above, management system 1302 may include one or more computers and/or servers or any combination thereof. Data collection devices 1304 may include, but are not limited to, user devices (including provider and requestor computing devices, such as those discussed above), provider communication devices, laptop or desktop computers, vehicle data (e.g., from sensors integrated into or otherwise connected to vehicles), ground-based or satellite-based sources (e.g., location data, traffic data, weather data, etc.), or other sensor data (e.g., roadway embedded sensors, traffic sensors, etc.). Data collection interface 1306 can include, e.g., an extensible device framework configured to support interfaces for each data collection device. In various embodiments, data collection interface 1306 may be extended to support new data collection devices as they are released and/or to update existing interfaces to support changes to existing data collection devices. In various embodiments, data collection devices may communicate with data collection interface 1306 over one or more networks. The networks may include any network or communication protocol as would be recognized by one of ordinary skill in the art, including those networks discussed above.

As shown in FIG. 13, data received from data collection devices 1304 can be stored in data 1308. Data 1308 may include one or more data stores, such as databases, object storage systems and services, cloud-based storage services, and other data stores. For example, various data stores may be implemented on a non-transitory storage medium accessible to management system 1302, such as historical data 1310, ride data 1312, and user data 1314. Data stores 1308 can be local to management system 1302, or remote and accessible over a network, such as those networks discussed above or a storage-area network or other networked storage system. The term “historical data,” as used herein, generally refers to any data recorded previously by the dynamic transportation matching system and/or any system from which the dynamic transportation matching system is capable of retrieving information. In various embodiments, historical data 1310 may include historical traffic data, weather data, request data, road condition data, or any other data for a given region or regions received from various data collection devices. Ride data 1312 may include route data, request data, timing data, and other ride related data, in aggregate and/or by requestor or provider. User data 1314 may include user account data, preferences, location history, and other user-specific data. Although certain data stores are shown by way of example, any data collected and/or stored according to the various embodiments described herein may be stored in data stores 1308.

As shown in FIG. 13, an application interface 1316 can be provided by management system 1302 to enable various apps 1318 to access data and/or services available through management system 1302. Apps 1318 may run on various user devices (including provider and requestor computing devices, such as those discussed above) and/or may include cloud-based or other distributed apps configured to run across various devices (e.g., computers, servers, or combinations thereof). Apps 1318 may include, e.g., aggregation and/or reporting apps which may utilize data 1308 to provide various services (e.g., third-party ride request and management apps). In various embodiments, application interface 1316 can include an API and/or SPI enabling third party development of apps 1318. In some embodiments, application interface 1316 may include a web interface, enabling web-based access to data 1308 and/or services provided by management system 1302. In various embodiments, apps 1318 may run on devices configured to communicate with application interface 1316 over one or more networks. The networks may include any network or communication protocol as would be recognized by one of ordinary skill in the art, including those networks discussed above, in accordance with an embodiment of the present disclosure.

While various embodiments of the present disclosure are described in terms of a networked transportation system in which the ride providers are human drivers operating their own vehicles, in other embodiments, the techniques described herein may also be used in environments in which ride requests are fulfilled using autonomous or semi-autonomous vehicles. For example, a transportation management system of a networked transportation service may facilitate the fulfillment of ride requests using both human drivers and autonomous vehicles. Additionally or alternatively, without limitation to transportation services, a matching system for any service may facilitate the fulfillment of requests using both human drivers and autonomous vehicles.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, by a dynamic transportation matching system, a request for transportation from a transportation requestor device;
determining, by the dynamic transportation matching system, that the request is eligible to be fulfilled by at least an unconstrained mode of transportation and a constrained mode of transportation, the constrained mode having at least one constraint that renders the constrained mode ineligible to fulfill one or more other transportation requests that the unconstrained mode is eligible to fulfill;
determining, by the dynamic transportation matching system, an expected impact that fulfilling the request via the constrained mode is expected to have on utilization of the constrained mode;
determining, by the dynamic transportation matching system, that the expected impact satisfies a utilization threshold for the constrained mode; and
directing, by the dynamic transportation matching system and in response to determining that the expected impact satisfies the utilization threshold, the transportation requestor device to present the constrained mode as an option for fulfilling the request for transportation.

2. The computer-implemented method of claim 1, wherein the constrained mode comprises an autonomous vehicle configured to fulfill the request for transportation without a human operating the autonomous vehicle.

3. The computer-implemented method of claim 1, wherein calculating the expected impact comprises predicting a future demand for the constrained mode during a window of time after the request for transportation was received.

4. The computer-implemented method of claim 3, wherein predicting the future demand for the constrained mode comprises at least one of:
determining a future demand for the constrained mode associated with a current location of the constrained mode; or
predicting, for an expected arrival time of the constrained mode at a destination specified by the request for transportation, a future demand for the constrained mode associated with the destination.

5. The computer-implemented method of claim 3, wherein:
determining the expected impact that fulfilling the request via the constrained mode is expected to have on the utilization of the constrained mode further comprises:
predicting an expected value of fulfilling the request via the constrained mode;
predicting an expected value of the future demand for the constrained mode; and
directing the transportation requestor device to present the constrained mode in response to determining that the expected value of fulfilling the request for transportation is greater than the expected value of the future demand.

6. The computer-implemented method of claim 3, wherein predicting the future demand expected to be received for the constrained mode comprises predicting an expected wait time for receiving a potential future request that is eligible to be fulfilled by the constrained mode.

7. The computer-implemented method of claim 1, wherein the utilization of the constrained mode comprises a percentage of operating time that the constrained mode is transporting a transportation requestor.

8. The computer-implemented method of claim 1, wherein:
calculating the expected impact comprises calculating an expected transit time of the constrained mode to a location of the transportation requestor device; and
directing the transportation requestor device to present the constrained mode is performed in response to determining that the expected transit time of the constrained mode to the location of the transportation requestor device satisfies a predetermined threshold for the expected transit time.

9. The computer-implemented method of claim 1, wherein directing the transportation requestor device to present the option for the constrained mode comprises:
selecting a format for presenting the option that is correlated with the expected impact of fulfilling the request via the constrained mode; and
directing the transportation requestor device to present the option in the selected format.

10. The computer-implemented method of claim 9, wherein the selected format comprises at least one of:
displaying the option highest in a list of options;
displaying text associated with the option in a larger font than a font in which additional options are displayed;
displaying at least one icon associated with the option in a larger size than an icon associated with an additional option; and
displaying the option in a different color than a color in which additional options are displayed.

11. The computer-implemented method of claim 1, further comprising:
receiving, by the dynamic transportation matching system, an additional request for transportation from an additional transportation requestor device;
determining, by the dynamic transportation matching system, that the additional request is eligible to be fulfilled by both the unconstrained mode and the constrained mode;
calculating an additional expected impact that fulfilling the additional request via the constrained mode is expected to have on the utilization of the constrained mode; and
directing, based on the additional expected impact, the additional transportation requestor device to not present the constrained mode as the option for fulfilling the request for transportation.

12. The computer-implemented method of claim 1:
further comprising determining that fulfilling the request for transportation improves at least one metric of the dynamic transportation network in addition to improving the utilization of the constrained mode; and
wherein directing the transportation requestor device to present the constrained mode as an option for fulfilling the request for transportation is performed in response to determining that fulfilling the request for transportation improves the at least one additional metric.

13. A transportation-matching system comprising:
a non-transitory memory; and
one or more hardware processors configured to execute instructions from the non-transitory memory to perform operations comprising:
receiving, by a dynamic transportation matching system, a request for transportation from a transportation requestor device;
determining, by the dynamic transportation matching system, that the request is eligible to be fulfilled by at least an unconstrained mode of transportation and a constrained mode of transportation, the constrained mode having at least one constraint that renders the constrained mode ineligible to fulfill one or more other transportation requests that the unconstrained mode is eligible to fulfill;
determining, by the dynamic transportation matching system, an expected impact that fulfilling the request via the constrained mode is expected to have on utilization of the constrained mode;
determining, by the dynamic transportation matching system, that the expected impact utilization satisfies a predetermined utilization threshold for the constrained mode; and
directing, by the dynamic transportation matching system and in response to determining that the expected impact satisfies the predetermined utilization threshold, the transportation requestor device to present the constrained mode as an option for fulfilling the request for transportation.

14. The transportation-matching system of claim 13, wherein the constrained mode comprises an autonomous vehicle that is configured to fulfill the request for transportation without a human operating the autonomous vehicle.

15. The transportation-matching system of claim 13, wherein determining the expected impact comprises predicting a future demand expected to be received for the constrained mode during a window of time after the request for transportation was received.

16. The transportation-matching system of claim 15, wherein predicting the future demand expected to be received for the constrained mode comprises at least one of:
determining a future demand for the constrained mode for a location of the constrained mode; or
predicting, for an expected arrival time of the constrained mode at a destination of the request for transportation, a future demand for the constrained mode for the destination.

17. The transportation-matching system of claim 15, wherein:
determining the expected impact that fulfilling the request via the constrained mode is expected to have on the utilization of the constrained mode further comprises:
predicting an expected value of fulfilling the request via the constrained mode; and
predicting an expected value of the future demand for the constrained mode; and
directing the transportation requestor device to present the constrained mode is performed in response to determining that the expected value of fulfilling the request for transportation is greater than the expected value of the future demand.

18. The transportation-matching system of claim 15, wherein predicting the future demand expected to be received for the constrained mode comprises predicting an expected wait time for receiving a potential future request that is eligible to be fulfilled by the constrained mode.

19. The transportation-matching system of claim 13, wherein:
calculating the expected impact comprises calculating an expected arrival time of the constrained mode at a location of the transportation requestor device; and
directing the transportation requestor device to present the constrained mode is performed in response to determining that the expected arrival time of the constrained mode at the location of the transportation requestor device satisfies a predetermined threshold for the expected arrival time.

20. A non-transitory computer-readable medium comprising computer-readable instructions that, when executed by at least one processor of a computing device, cause the computing device to:
receive, by a dynamic transportation matching system, a request for transportation from a transportation requestor device;
determine, by the dynamic transportation matching system, that the request is eligible to be fulfilled by at least an unconstrained mode of transportation and a constrained mode of transportation, the constrained mode having at least one constraint that renders the constrained mode ineligible to respond to one or more other transportation requests that the unconstrained mode is eligible to fulfill;
determine, by the dynamic transportation matching system, an expected impact that fulfilling the request via the constrained mode is expected to have on utilization of the constrained mode;
determine, by the dynamic transportation matching system, that the expected impact utilization satisfies a predetermined utilization threshold for the constrained mode; and
direct, by the dynamic transportation matching system and in response to determining that the expected impact satisfies the predetermined utilization threshold, the transportation requestor device to present the constrained mode as an option for fulfilling the request for transportation.
